(19) United States
(12) Patent Application Publication
(10) Pub. No.: US 2022/0355898 A1
(43) Pub. Date: Nov. 10, 2022

(54) REAR DRIVE TRANSMISSION SYSTEM OF MOTORCYCLE AND MOTORCYCLE

(71) Applicant: QINGDAO CHOHO INDUSTRIAL CO.,LTD., Qingdao (CN)

(72) Inventors: Zhenming Fu, QINGDAO (CN); Yumo Jin, QINGDAO (CN)

(21) Appl. No.: 17/308,020

(22) Filed: May 4, 2021

(51) Int. Cl. B62M 9/08

(52) U.S. Cl. CPC B62M 9/08

(57) ABSTRACT

A rear drive transmission system for a motorcycle includes a driving wheel, a center wheel, and a driven wheel. The center wheel includes a transmission wheel A and a transmission wheel B that are coaxially arranged. The transmission wheel A is fixedly connected to an opposite surface of the transmission wheel B. The driving wheel is drivingly connected to the transmission wheel B. The transmission wheel A is drivingly connected to the driven wheel, and the driving wheel is detachably and fixedly connected to an output shaft of a motor or engine. The driven wheel is detachably connected with a rear wheel shaft of the motorcycle. The center wheel is rotatably connected with a rear fork rotation center shaft through a bearing. The motorcycle is with the motorcycle rear drive transmission system.

### TECHNICAL FIELD

This disclosure relates to the technical field of motorcycles, and more particularly relates to a motorcycle rear drive transmission system and a motorcycle.

### BACKGROUND

At present, the rear driving transmission mode of motorcycles mainly adopts chain transmission, which solves the driving problem of motorcycles through the chain transmission between the output shaft of the engine and the rear wheel shaft.

In the design of the related art, in addition to considering the characteristics of simple chain transmission structure, light weight, low cost, and easy maintenance, another important reason is that the motorcycle rear fork with the drive wheel will vibrate during violent movement, and the chain is When adjusting the tightness, a certain margin can be given, so as to adapt to the vibration of the rear fork and maintain the transmission between the engine and the rear wheels.

However, with the continuous development of the industry, the existing motorcycle chain drive system has increasingly highlighted its technical limitations, which are embodied in that with the increasing demand for large-displacement traveling, cross-country, competitive and other motorcycles and high-end electric motorcycles, traditional chain drives cannot adapt to the severe vibration needs of these motorcycles, especially when moving at high speeds, the vibration amplitude of the rear fork increases. When the center shaft of the rear fork, the rear wheel shaft, and the center of the engine drive wheel are in a line, the center distance between the engine sprocket and the rear wheel sprocket reaches the maximum. At this time, the danger of sudden chain breakage is extremely likely to occur. If you reserve too much of the chain's tightness when installing the chain, it will cause the speedometer sensor to malfunction, wear the chain sprocket, and the chain will detach from the sprocket.

### SUMMARY

In order to solve the problems in the related art, the present disclosure provides a motorcycle rear drive transmission system and a motorcycle. By redesigning the motorcycle transmission system, it overcomes the technical limitations of traditional chain transmission and enables the motorcycle to operate at high speeds, maintaining the stability of the transmission system during strenuous exercise, which can effectively avoid dangerous accidents.

In order to achieve the above objective, the technical solution of the present disclosure is a rear drive transmission system of a motorcycle, including a driving wheel, a center wheel, and a driven wheel. The center wheel includes a coaxially arranged transmission wheel A and a transmission wheel B, the transmission wheel A fixedly connected to the opposite surface of the transmission wheel B, the driving wheel is drivingly connected to the transmission wheel B, the transmission wheel A is drivingly connected to the driven wheel, and the driving wheel is detachably and fixedly connected to the output shaft of the motor or engine, the driven wheel is detachably connected with the rear wheel shaft of the motorcycle, and the center wheel is rotatably connected with the rear fork rotation center shaft through a bearing.

Typically, the outer diameter of the driving wheel is smaller than the outer diameter of the center wheel, and the outer diameter of the center wheel is smaller than the outer diameter of the driven wheel.

Typically, one end of the rear fork rotation center shaft extends outward, and a bearing is installed on the extended rear fork center shaft.

Typically, the driving wheel, the center wheel, and the driven wheel are sprockets.

Typically, the number of teeth of the sprocket is 12 to 72 teeth.

Typically, the driving wheel, the center wheel, and the driven wheel are pulleys.

Typically, the transmission wheel And the transmission wheel B, and the transmission wheel A and the driven wheel are respectively connected by a toothed belt drive.

Typically, the driving wheel and the transmission wheel B are drivingly connected in a meshing manner.

Typically, a motorcycle is provided with the motorcycle rear drive transmission system.

The rear drive transmission system of a motorcycle and the motorcycle of the present disclosure have the following beneficial effects:

(1) The present disclosure changes the primary transmission to the secondary transmission by setting the center wheel on the central axis of the rear fork rotation, respectively realizing the constant center distance between the transmission wheel And the center wheel, and between the center wheel and the driven wheel, making the chain drive stable and eliminate the hidden danger of sudden chain breakage caused by the increase of center distance.

(2) The present disclosure can change the transmission ratio by adjusting the number of teeth of the center wheel, transmission wheel And driven wheel to improve the efficiency, smoothness and durability of chain transmission.

The present disclosure can not only select roller chains, sleeve chains, and toothed chains for chain transmission, but also select toothed belts for pulley transmission, and can also mesh and drive between the transmission wheel And the transmission wheel B, passing through the center The setting of the wheels realizes a variety of optional transmission modes, which can improve the wear resistance, fatigue resistance and stability of the transmission, reduce the transmission noise, and realize the silent transmission.

### BRIEF DESCRIPTION OF DRAWINGS

FIG. 1 is a schematic front view of a rear drive transmission system of a motorcycle according to an embodiment of the present disclosure.

FIG. 2 is a front longitudinal sectional schematic diagram of a motorcycle rear drive transmission system according to an embodiment of the present disclosure.

FIG. 3 is schematic top view illustrating the fitting relationship between the transmission wheel A and the transmission wheel B of the present disclosure.

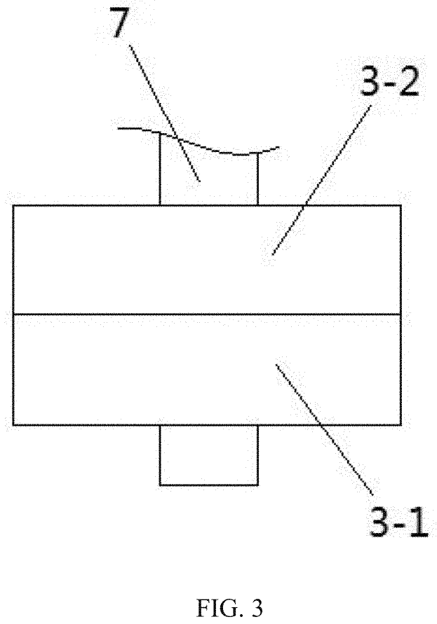

1: Driving wheel; 2: Primary drive chain or belt; 3: Center wheel; 4: Secondary drive chain or belt; 5: Driven wheel; 6: Bearing; 7: Rear fork rotation central shaft; 3-1: Drive Wheel A, 3-2: Transmission wheel B.

### DETAILED DESCRIPTION

The following is a detailed description of the implementation of the present disclosure in a stepwise manner. The description is only a typical embodiment of the present disclosure, and is not intended to limit the scope of protection of the present disclosure. It is in the spirit and principle of the present disclosure. Any modifications, equivalent replacements and improvements made within the scope of protection shall be included in the protection scope of the present disclosure.

In the description of the present disclosure, it should be noted that the directions or positional relationships indicated by the terms “up”, “down”, “left”, “right”, “top”, “bottom”, “inner”, and “outer” are based on the drawings shown The orientation or positional relationship is only for describing the present disclosure and simplifying the description, rather than indicating or implying that the pointed device or element must have a specific orientation, and a specific orientation structure and operation, so it cannot be understood as a limitation of the present disclosure.

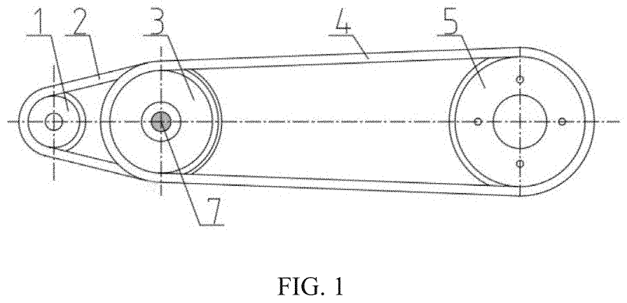

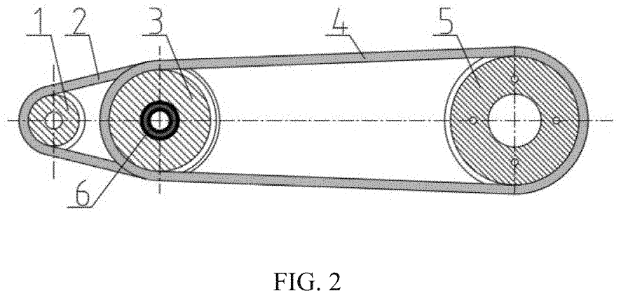

As shown in FIGS. 1 and 2, in one embodiment, a motorcycle rear drive transmission system of the present disclosure includes a driving wheel 1, a center wheel 3, and a driven wheel 5. The center wheel 3 includes a coaxial arrangement The transmission wheel A3-1 and the transmission wheel B3-2 are fixedly connected to the opposite surfaces of the transmission wheel A3-1 and the transmission wheel B3-2, and the driving wheel 1 is drivingly connected to the transmission wheel B3-2. The transmission wheel A3-1 is in transmission connection with the driven wheel 5. The driving wheel 1 is detachably and fixedly connected with the output shaft of the motor or engine, and the driven wheel 5 is detachably and fixedly connected with the motorcycle rear axle. The center wheel 3 and the rear fork rotation center shaft 7 are rotatably connected through the bearing 6; because the motor or engine is arranged on the main frame of the motorcycle, the driving wheel 1 and the center wheel 3 connected to the motor or engine have a constant center distance In addition, since the center wheel 3 is arranged on the center shaft 7 of the rear fork rotation, the center wheel 3 and the driven wheel 5 also have a constant center distance. In the high-speed and vigorous movement of the motorcycle, the center distance is unchanged, so that the transmission The system structure is stable, and there is no danger of severe damage to the transmission due to rear fork vibration.

In a further embodiment, the outer diameter of the driving wheel 1 is smaller than the outer diameter of the center wheel 3, and the outer diameter of the center wheel 3 is smaller than the outer diameter of the driven wheel 5.

In a further embodiment, one end of the rear fork rotation center shaft 7 extends outward, and a bearing is installed on the extended rear fork center shaft.

In a further embodiment, the driving wheel 1, the center wheel 3, and the driven wheel 5 are sprockets; as shown in FIG. 1 and FIG. 2, since the center distance is constant, the chain can be avoided when driving through a chain. The danger of breaking.

In a further embodiment, the number of teeth of the sprocket is 12 teeth.

In a further embodiment, unlike the previous embodiment, the number of teeth of the sprocket is 72 teeth.

In a further embodiment, the driving wheel 1, the center wheel 3, and the driven wheel 5 are pulleys.

In a further embodiment, the driving wheel 1 and the transmission wheel B, and the transmission wheel A and the driven wheel 5 are respectively connected by a toothed belt transmission; the present disclosure realizes a simple way of motorcycle pulley transmission through technical improvements, Compared with the sprocket, it can reduce the vibration during sound making and transmission, and has the advantages of simple structure, stable operation and easy adjustment.

In a further embodiment, the driving wheel 1 and the transmission wheel B are connected in a meshing manner; through meshing transmission, it has the advantages of high transmission accuracy, high transmission efficiency, reliable operation and long service life.

In a further embodiment, a motorcycle is provided with the rear drive transmission system of the motorcycle.

What is claimed is:

1. A rear drive transmission system of a motorcycle, comprising:
a driving wheel;
a center wheel; and
a driven wheel;
wherein the center wheel comprises a transmission wheel A and a transmission wheel B that are coaxially arranged, wherein the transmission wheel A is fixedly connected to an opposite surface of the transmission wheel B, the driving wheel is drivingly connected to the transmission wheel B, the transmission wheel A is drivingly connected to the driven wheel, and the driving wheel is detachably and fixedly connected to an output shaft of a motor or engine, the driven wheel is detachably connected to a rear wheel shaft of the motorcycle, and the center wheel is rotatably connected to a rear fork rotation center shaft through a bearing.

2. The motorcycle rear drive transmission system of claim 1, wherein an outer diameter of the driving wheel is smaller than an outer diameter of the center wheel, and the outer diameter of the center wheel is smaller than an outer diameter of the driven wheel.

3. The motorcycle rear drive transmission system of claim 1, wherein one end of the rear fork rotation center shaft extends outward, and a bearing is installed on the extended rear fork center shaft.

4. The motorcycle rear drive transmission system of claim 1, wherein the driving wheel, the center wheel, and the driven wheel are sprockets.

5. The motorcycle rear drive transmission system of claim 4, wherein the sprocket comprises a number of 12 to 72 teeth.

6. The motorcycle rear drive transmission system of claim 1, wherein the driving wheel, the center wheel, and the driven wheel are pulleys.

7. The motorcycle rear drive transmission system of claim 6, wherein the driving wheel and the transmission wheel B, and the transmission wheel A and the driven wheel are respectively connected by a toothed belt drive.

8. The motorcycle rear drive transmission system of claim 1, wherein the driving wheel and the transmission wheel B are drivingly connected in a meshing manner.

9. The motorcycle rear drive transmission system of any one of claim 1, wherein the motorcycle is with the motorcycle rear drive transmission system.
